(19) United States
(12) Patent Application Publication
(10) Pub. No.: US 2009/0110234 A1
(43) Pub. Date: Apr. 30, 2009

(54) IMAGE PROCESSING SYSTEM AND METHOD THEREOF APPLIED WITH INSTANT MESSAGING PROGRAM

(75) Inventors: Chung-Jen Yang, Taipei City (TW); Tung-Heng Chang, Kinmen County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SERCOMM CORPORATION, Taipei (TW)

(21) Appl. No.: 12/133,431

(22) Filed: Jun. 5, 2008

Related U.S. Application Data
(60) Provisional application No. 60/983,591, filed on Oct. 30, 2007.

(51) Int. Cl. G06K 9/00

(52) U.S. Cl. 382/100

(57) ABSTRACT

An image processing method for providing an output image for an instant messaging program is provided. The image processing method includes the following steps. Firstly, an image capturer captures an input image. Next, the input image is inputted to a dump memory block. Then in response to an operating event, a drawing data is input to a canvas memory block. The storing sizes of the dump memory block and the canvas memory block are substantially the same. Next, the drawing data is obtained from the canvas memory and is combined with the input image, so that an output image is generated in the dump memory block. The instant messaging program controls a virtual image capturer to obtain the output image from the dump memory block.

This application claims the benefit of U.S. provisional application Ser. No. 60/983,591, filed Oct. 30, 2007, the subject matter of which is incorporated herein by reference.

### BACKGROUND OF THE INVENTION

1. Field of the Invention

The invention relates in general to an image processing system and an image processing method, and more particularly to an image processing system and a method thereof applied with instant messaging program.

2. Description of the Related Art

Instant image transmission is widely used in instant messaging program, such as MSN Messenger. By using a WebCam to capture an image, the user of the instant messaging program can instantly transmit the image captured by the WebCam to another user. Thus, the user can share images with another user. However, conventional image transmission can only transmit the image captured by the WebCam and cannot provide any special effects. Thus, the instant messaging program merely using conventional image transmission cannot provide the user with more experiences of use. Thus, how to add special effects to the captured image to make the use of the instant messaging program more versatile has become an imminent goal to achieve.

### SUMMARY OF THE INVENTION

The invention is directed to an image processing system and an image processing method. When a user draws with a utility and then inputs the drawing data, the image processing system of the invention combines the drawing data and an input image captured by an image capturer to generate an output image and provide the output image to the instant messaging program. Thus, the instant messaging program transmits the combined output image instantly to other users. Thus, the user can experience the fun of instantly drawing on the input image captured by the image capturer, and sharing the combined output image instantly with other users.

According to a first aspect of the present invention, an image processing method for providing an output image to an instant messaging program is provided. The image processing method includes the following steps. Firstly, an image capturer captures an input image. Next, the input image is inputted to a dump memory block. Then, in response to an operating event, a drawing data is input to a canvas memory block. The storing sizes of the dump memory block and the canvas memory block are substantially the same. Next, the drawing data is obtained from the canvas memory, and is combined with the input image to generate an output image. The instant messaging program controls a virtual image capturer to obtain the output image from the dump memory block.

According to a second aspect of the present invention, an image processing system for generating an output image to an instant messaging program is provided. The image processing system includes an image processing module, a canvas memory block and a utility. The image processing module includes an image capturer and a dumper. The image capturer captures an input image. The dumper inputs the input image to a dump memory block. The storing sizes of the dump memory block and the canvas memory block are substantially the same. The utility, in response to an operating event, stores a drawing data to the canvas memory block. The dumper obtains drawing data from the canvas memory, and combines the drawing data with the input image stored in the dump memory block to generate an output image. The instant messaging program controls a virtual image capturer to obtain the output image from the dump memory block.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of an image processing system of the invention embodiment;

FIG. 2 shows a flowchart of an image processing method executed by the image processing system of FIG. 1;

FIG. 3 shows an example of combining the input image and the drawing data to generate an output image.

### DETAILED DESCRIPTION OF THE INVENTION

The image processing method of the present embodiment of the invention is for generating an output image to an instant messaging program. The image processing method of the present embodiment of the invention includes the following steps. Firstly, an image capturer captures an input image. Next, the input image is inputted to a dump memory block. Besides, in response to an operating event, a drawing data is inputted to a canvas memory block. The storing sizes of the dump memory block and the canvas memory block are substantially the same. Then, the drawing data is obtained from the canvas memory, and is combined with the input image to generate an output image. The instant messaging program controls a virtual image capturer to obtain the output image from the dump memory block.

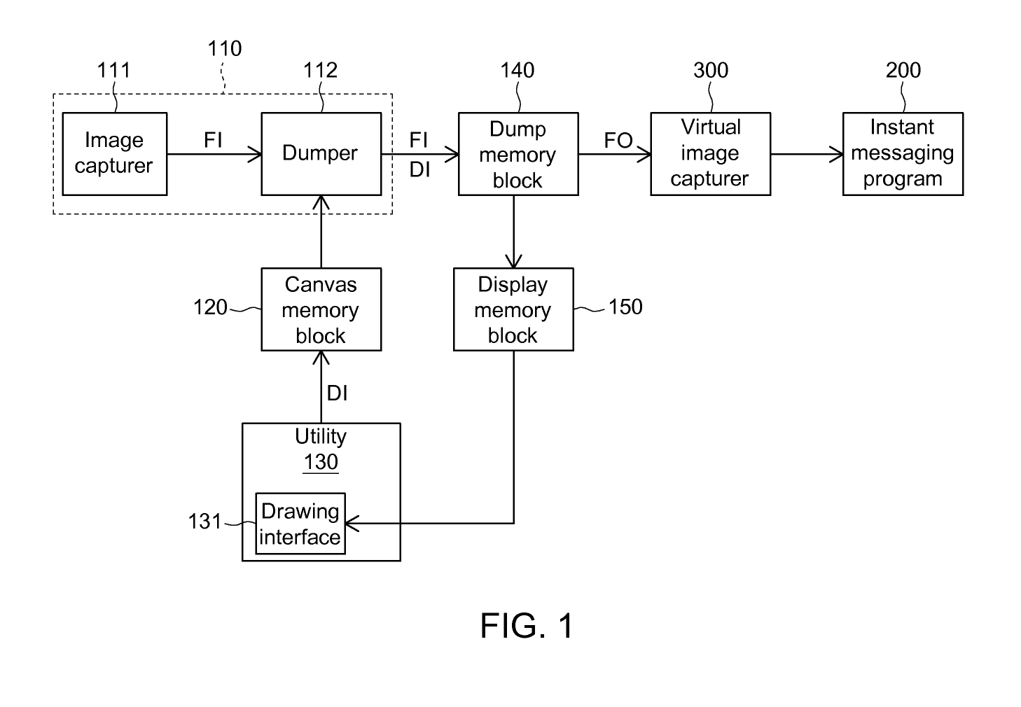

FIG. 1 shows a block diagram of an image processing system of the present embodiment. Referring to FIG. 1, the image processing system includes an image processing module 110, a canvas memory block 120 and a utility 130. The image processing module 110 includes an image capturer 111 and a dumper 112. The image processing system captures an input image FI, and receives a drawing data DI and combines the input image FI with the drawing data DI to generate an output image FO in response to an operation. The input image FO is stored in a dump memory block 140 and is used by an instant messaging program 200. The instant messaging program 200 controls a virtual image capturer 300 to obtain the output image FO from the dump memory block 140.

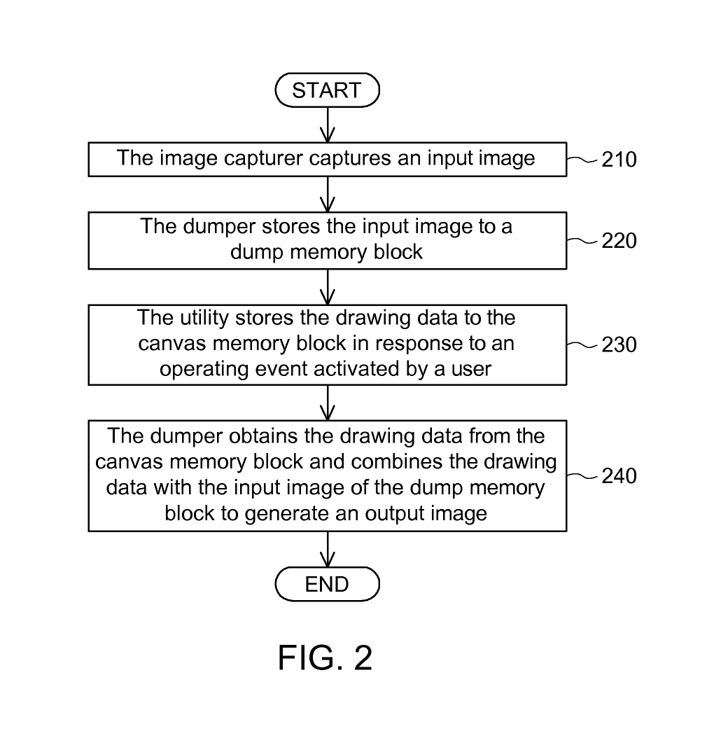

FIG. 2 shows a flowchart of an image processing method executed by the image processing system of FIG. 1. Referring to both FIG. 1 and FIG. 2. In step 210, the image capturer 111 captures an input image FI. Next, in step 220, the dumper 112 stores the input image FI to a dump memory block 140.

In step 230, the utility 130 stores the drawing data DI to the canvas memory block 120 in response to an operating event activated by a user. In the present embodiment, the utility 130 includes a drawing interface 131. The operating event is inputted to the drawing data DI by the drawing interface 131. The utility 130 stores the drawing data DI of the drawing interface 131 to the canvas memory block 120 in response to the operating event. In the present embodiment, the drawing data DI includes the pixels corresponding to the image drawn on the drawing interface 131 by the user. For example, if the user draws a line on the drawing interface 131, then the drawing data DI includes each pixel of the image corresponding to the line.

Next, in step 240, the dumper 112 obtains the drawing data DI from the canvas memory block 120, and combines the drawing data DI with the input image FI of the dump memory block 140 to generate an output image FO. The dumper 112 stores the output image FO to the dump memory block 140.

In the present embodiment, the storing sizes of the canvas memory block 120 and the dump memory block 140 are substantially the same. For example, the size of the input image FI captured by the image capturer 111 and the size of the image of drawing data DI on the drawing interface 131 are both 320×240. Each pixel of the input image FI and the drawing data DI is 1 byte. Correspondingly, the storing sizes of the dump memory block 140 and the canvas memory block 120 are 76800 (320×240) bytes for storing each pixel of the input image FI and the drawing data DI.

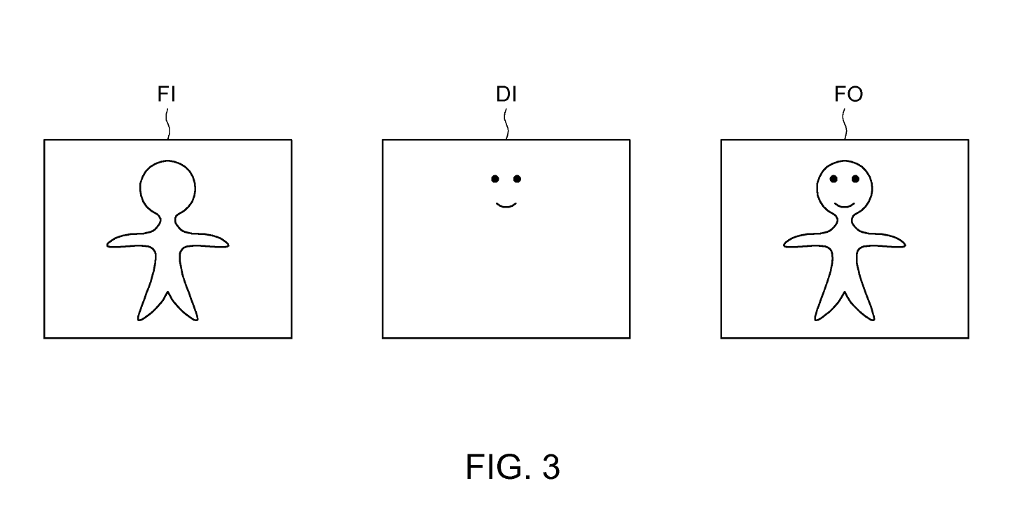

In step 240, the dumper 112 combines each pixel of the drawing data DI stored in the canvas memory block 120 and each pixel in the same position of the input image FI stored in the dump memory block 140. FIG. 3 shows an example of combining the input image FI and the drawing data DI to generate an output image FO. Referring to FIG. 3, the dumper 112 overlaps the drawing data DI on the input image FI to generate the output image FO.

Besides, the dumper 112 further controls the transparency of the drawing data DI on the output image FO according to a transparency coefficiency k determined by the user. In the present embodiment, the dumper 112 generates a pixel FO(x, y) in the position (x, y) of an output image FO according to the transparency coefficiency k, a pixel FI(x, y) in the position (x, y) of the input image FI, and a pixel DI(x, y) in the same position (x, y) of the drawing data DI. Wherein, x denotes the horizontal coordinate of the input image FI, the drawing data DI or the output image FO, and y denotes the vertical coordinate of the input image FI, the drawing data DI or the output image FO. Formulas 1 is an example of the relationship between the pixel FO(x, y) and FI(x, y) and DI(x, y).

FO(x,y)=(100%−k%)×DI(x,y)+k%×FI(x,y) Formulas 1

As indicated in Formulas 1, the transparency coefficiency k determines the weight of the pixel DI (x, y) and the pixel FI (x, y) in the pixel FO (x, y). For example, if the transparency coefficiency is set as 0%, then the pixel FO (x, y) of the output image is equal to DI (x, y), and the pixel FI (x, y) does not carry any weight in FO (x, y). That is, the pixel DI (x, y) of the drawing data DI is non-transparent. Similarly, if the transparency coefficiency is set as 50%, then the pixel DI (x, y) of the drawing data DI is semi-transparent.

Thus, the image processing system of the present embodiment of the invention obtains an output image FO which is a combination of the input image FI and the drawing data DI, and further stores the output image FO to the dump memory block 140 to be used by a Messenger 200. Thus, the Messenger 200 can control a virtual image capturer 300 to obtain the output image 140.

Besides, in the present embodiment of the invention, the utility 130 further reads the output image FO from the dump memory block 140, and displays the output image FO on the drawing interface 131. In the present embodiment of the invention, the utility 130 stores the output image FO to a display memory block 150 so as to display the output image FO on the drawing interface 131. Similarly, the storing sizes of the display memory block 150 and the dump memory block 140 are substantially the same.

In the present embodiment of the invention, the image capturer is a WebCam.

In the present embodiment of the invention, the image processing system is embodied by DirectShow technology. The image processing module 110 is a set of filter graphic manager. The image capturer 111 is a source filter of the set of filter graphic manager, and the dumper 112 is a render filter of the set of filter graphic manager. Similarly, the instant messaging program and the virtual image capturer form another set of filter graphic manager. The virtual image capturer is a source filter of another set of filter graphic manager, and the instant messaging program is a render filter of another set of filter graphic manager.

The effects of the image processing system and method thereof disclosed in of the present embodiment of the invention are elaborated below. The image processing system controls an image capturer, such as a WebCam, to captures an input image and at the same time receives a drawing data inputted by a user via a drawing interface. When the user uses a drawing interface of the utility to draw and the drawing data is inputted, the image processing system of the invention combines the drawing data with the input image to generate an output image and further provides the output image to the instant messaging program. Thus, the instant messaging program transmits the combined output image instantly to other users. Thus, by overlapping several continuous input images with the drawing data to form several continuous output images, the user can experience the fun of instantly drawing on the input image captured by the image capturer, and sharing the combined output image instantly with other users. Comparatively, if the instant messaging program of the image processing system of the invention is not used, the user can only transmit the input image captured by the image capturer to other users without providing any special effects. The image processing system and the image processing method disclosed in the embodiments of the invention provide the user of the instant messaging program another use experience.

Besides, the utility displays the output image on the drawing interface. By displaying the output image on the drawing interface, the user can directly view the output image of the drawing interface, and draw on the drawing interface. Thus, the operation of inputting the drawing data through the drawing interface becomes further smoother.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing method for providing an output image to an instant messaging program, the method comprising:
(a) capturing an input image by an image capturer;
(b) inputting the input image to a dump memory block;
(c) inputting a drawing data to a canvas memory block in response to an operating event, wherein the storing sizes of the canvas memory block and the dump memory block are substantially the same; and
(d) obtaining the drawing data from the canvas memory block, and combining the drawing data with the input image of the dump memory block to generate an output image;
wherein, the instant messaging program controls a virtual image capturer to obtain the output image from the dump memory block.

2. The image processing method according to claim 1, wherein, in step (c), a utility, in response to the operating event, stores the drawing data to the canvas memory block.

3. The image processing method according to claim 2, wherein, the utility comprises a drawing interface, and stores the drawing data of the drawing interface to the canvas memory block in response to the operating event.

4. The image processing method according to claim 3, wherein, the image processing method further comprises:
(e) reading the output image from the dump memory block by the utility, and further displaying the output image on the drawing interface.

5. The image processing method according to claim 4, wherein, in step (e), the utility reads the output image from the dump memory block, stores the output image to a display memory block, and displays the output image on the drawing interface;
wherein, the storing sizes of the display memory block and the dump memory block are substantially the same.

6. The image processing method according to claim 1, wherein, in step (d), the drawing data is combined with the input image of the dump memory block according to a transparency coefficiency to generate an output image.

7. The image processing method according to claim 1, wherein, in step (a), the image capturer is a source filter of a DirectShow, in step (b), a render filter of the DirectShow stores the input image to the dump memory block, and in step (d), the render filter reads the drawing data from the canvas memory block, and combines the drawing data with the input image of the dump memory block.

8. The image processing method according to claim 1, wherein, the image capturer is a WebCam.

9. An image processing system for generating an output image to an instant messaging program, the system comprising:
an image processing module, comprising:
an image capturer for capturing an input image; and
a dumper for inputting the input image to a dump memory block;
a canvas memory block, wherein the storing sizes of the canvas memory block and the dump memory block are substantially the same; and
a utility for storing a drawing data to the canvas memory block in response to an operating event;
wherein, the dumper obtains the drawing data from the canvas memory block, and combines the drawing data with the input image of the dump memory block to generate an output image;
wherein, the instant messaging program controls a virtual image capturer to obtain the output image from the dump memory block.

10. The image processing system according to claim 9, wherein, the utility comprises a drawing interface, and the unitily stores the drawing data of the drawing interface to the canvas memory block in response to the operating event.

11. The image processing system according to claim 10, wherein, the utility obtains the output image from the dump memory block, and displays the output image on the drawing interface.

12. The image processing system according to claim 11, wherein, the utility reads the output image from the dump memory block, stores the output image to a display memory block, and displays the output image on the drawing interface, wherein, the storing sizes of the display memory block and the dump memory block are substantially the same.

13. The image processing system according to claim 9, wherein, the dumper combines the drawing data with the input image of the dump memory block according to a transparency coefficiency to generate an output image.

14. The image processing system according to claim 9, wherein, the image processing system is embodied by a DirectShow, the image capturer is a source filter, and the dumper is a render filter.

15. The image processing system according to claim 9, wherein, the image capturer is a WebCam.
